(19) United States
(12) Patent Application Publication
(10) Pub. No.: US 2008/0112257 A1
(43) Pub. Date: May 15, 2008

(54) MIXING DEVICE FOR TUB

(76) Inventor: Masatoshi MASUDA, Kyoto (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/858,090

(22) Filed: Sep. 19, 2007

(30) Foreign Application Priority Data
Nov. 10, 2006 (JP) 2006-304660
May 9, 2007 (JP) 2007-124115
Aug. 24, 2007 (JP) 2007-218069

(51) Int. Cl. B01F 13/02

(52) U.S. Cl. 366/101

(57) ABSTRACT

A fluid mixing apparatus configured to be connected to a tub, a liquid supply, and a gas supply, includes: a 1^{st} pressurable liquid-storing chamber for storing liquid and mixing gas into liquid; a 2^{nd} pressurable liquid-storing chamber for storing liquid and mixing gas into liquid; and a connection path connecting the 1^{st} and 2^{nd} liquid-storing chamber for supplying liquid from the 1^{st} liquid-storing chamber to the 2^{nd} liquid-storing chamber where the pressure inside the 2^{nd} liquid-storing chamber is lower than the pressure inside the 1^{st} liquid-storing chamber. The 2^{nd} liquid-storing chamber is disposed downstream of the 1^{st} liquid-storing chamber with respect to liquid flow.

### BACKGROUND OF THE INVENTION

1. Field of the Invention

The present invention generally relates to a fluid mixing device for a tub which mixes gas and liquid in order to supply a tub.

2. Description of the Related Art

The device in Japanese Patent Laid-open No. 2001-145676 is known as a device which mixes gas with liquid to supply this kind of tub. The device disclosed in Japanese Patent Laid-open No. 2001-145676 provides a tub, a jet nozzle which sprays a jet flow to a tub, and an air intake which connects to the jet nozzle by means of an air flow pipe. Thus, according to the device disclosed in Japanese Patent Laid-open No. 2001-145676, it is possible to supply liquid which has mixed with the gas in the tub, and it is possible to enhance the effect of a warm bath.

However, for the device disclosed in Japanese Patent Laid-open No. 2001-145676, because there is simply only the supply of gas through the air flow pipe to the liquid which is to be supplied to the tub, it is not possible to mix enough gas. If it is not possible to mix enough gas, the gas from the liquid which was mixed in the tub will immediately flow out, and it will not be possible to achieve a sufficient warm bath effect.

### SUMMARY OF THE INVENTION

With this type of bath mixing apparatus, however, mixing of a large amount of gas into liquid creates the problem of the supplied mixed liquid generating bubbles in the bath. If bubbles generate in the bath, the transparency of the mixed liquid in the bath decreases and the bath user also feels unpleasant.

An embodiment of the present invention was developed to solve at least one of the aforementioned problems, and in an embodiment, one of objects of the present invention is to provide a tub apparatus capable of minimizing the amount of bubbles generated by the mixed liquid in the tub.

The invention described in Embodiment 1 is a tub apparatus for supplying to a tub a mixed liquid comprising liquid mixed with gas, which is characterized by having: a first mixing chamber having supply pipes through which mixed liquid is supplied, used to store mixed liquid at the bottom, and having a first internal pressure maintained at a level higher than the atmospheric pressure; a second mixing chamber having supply pipes through which mixed liquid is supplied, used to store mixed liquid at the bottom, and having a second internal pressure maintained at a level equal to or higher than the atmospheric pressure but lower than the first pressure in the first chamber; a mixed liquid circulation mechanism for circulating mixed liquid through the chambers in the order of the first mixing chamber and second mixing chamber and then returning it to the tub; a liquid supply part that supplies liquid to one of the mixed liquid circulation lines including the circulation lines for the tub, first mixing chamber and second mixing chamber; and a gas supply part that supplies gas to one of the mixed liquid circulation lines including the circulation lines for the tub, first mixing chamber and second mixing chamber.

The invention described in Embodiment 2 is a tub apparatus according to Embodiment 1, further having: a gas supply line that connects the first and second mixing chambers to the gas supply part via a valve; sensors that measure the pressures in the first and second mixing chambers; and a control part that controls the opening/closing of the valve based on the pressure values detected by the sensors.

The invention described in Embodiment 3 is a tub apparatus according to Embodiment 1 or 2, wherein a metering or chock valve is provided between the first mixing chamber and second mixing chamber, and also between the second mixing chamber and tub.

The invention described in Embodiment 4 is a tub apparatus according to Embodiment 1 or 2, wherein a liquid-storing chamber is provided between the second mixing chamber and tub for temporarily storing mixed liquid.

The invention described in Embodiment 5 is a tub apparatus according to any one of Embodiments 1 to 4, wherein the supply pipes have many holes for injecting mixed liquid into the space above the levels of mixed liquid stored in the first and second mixing chambers.

The invention described in Embodiment 6 is a tub apparatus according to Embodiment 5, wherein sensors are provided that detect the levels of mixed liquid stored in the first and second mixing chambers.

The invention described in Embodiment 7 is a tub apparatus according to any one of Embodiments 1 to 6, wherein a metering or chock valve is provided near the supply port to the tub along the conduit through which to supply mixed liquid to the tub.

The invention described in Embodiment 8 is a tub apparatus according to any one of Embodiments 2 to 7, wherein the feed rate of gas supplied from the gas supply part is increased for a certain period if the pressure values detected by the sensors drop to below a specified value.

The invention described in Embodiment 9 is a tub apparatus according to Embodiment 8, wherein the supply of gas from the gas supply part is stopped for a certain period if the pressure values detected by the sensors drop to below a specified value, and after elapse of a specified period the feed rate of gas supplied from the gas supply part is increased for a certain period to a level higher than the feed rate before the supply was stopped.

The invention described in Embodiment 10 is a tub apparatus according to Embodiment 9, wherein the control part repeats the stopping and supplying of gas for a certain period until a specified pressure is reached.

According to the invention described in Embodiment 1, the amount of bubbles generated by the mixed liquid in the tub can be minimized.

According to the invention described in Embodiment 2, the pressures in the first and second mixing chambers can be maintained at appropriate levels.

According to the invention described in Embodiment 3, the pressures in the first and second mixing chambers can be raised with ease.

According to the invention described in Embodiment 4, the amount of bubbles generated by the mixed liquid in the tub can be further reduced.

According to the invention described in Embodiment 5, gas can be mixed into liquid with ease.

According to the invention described in Embodiment 6, the levels of mixed liquid in the first and second mixing chambers can be maintained at appropriate levels.

According to the invention described in Embodiment 7, the bubbles generated by the mixed liquid as it is supplied to the tub can be made finer.

According to the invention described in any one of Embodiments 8 to 10, drop in the content of dissolved gas due to pressure drop in the mixing chambers can be prevented.

For purposes of summarizing the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not to scale.

FIG. 1 is a perspective view of a tub 3 that applies a tub apparatus conforming to an example of the present invention.

FIG. 2 is a schematic diagram of a tub apparatus conforming to an example of the present invention.

FIG. 3 is a partial side section view of a supply pipe 220.

FIG. 4 is a block diagram of a key electrical configuration of a tub apparatus conforming to an example of the present invention.

FIG. 5 is a schematic diagram of a tub apparatus conforming to another example of the present invention

### DESCRIPTION OF SYMBOLS

3 Tub
10 First mixing chamber
11 Conduit
12 Circulation pump
13 Pressure sensor
14 Open/close valve
15 Open/close valve
16 Level sensor
20 Second mixing chamber
21 Conduit
22 Circulation pump
23 Pressure sensor
Open/close valve
25 Open/close valve
26 Level sensor
30 Liquid-storing chamber
34 Open/close valve
36 Level sensor
41 Gas supply part
42 Mixing mechanism
51 Liquid supply part
52 Conduit
53 Conduit
54 Conduit
55 Conduit
56 Conduit
57 Circulation pump
58 Metering or chock valve
59 Metering or chock valve
60 Control part
71 Conduit
72 Conduit
81 Metering or chock valve
82 Metering or chock valve
83 Metering or chock valve
91 Liquid supply part
220 Supply pipe
221 Hole

### DETAILED DESCRIPTION OF THE PREFERRED EMBODIMENT

The present invention will be explained in detail with reference to preferred embodiments. However, the preferred embodiments are not intended to limit the present invention.

In an embodiment of the present invention, a fluid mixing apparatus configured to be connected to a tub (e.g., 3), a liquid supply (e.g., 51, 91), and a gas supply (e.g., 41), comprising: (i) a 1^{st} liquid-storing chamber (e.g., 10) for storing liquid and mixing gas into liquid, said 1^{st} liquid-storing chamber being pressurable; (ii) a 2^{nd} liquid-storing chamber (e.g., 20) for storing liquid and mixing gas into liquid, said 2^{nd} liquid-storing chamber being pressurable; and (iii) a connection path (e.g., 54) connecting the 1^{st} liquid-storing chamber and the 2^{nd} liquid-storing chamber for supplying liquid from the 1^{st} liquid-storing chamber to the 2^{nd} liquid-storing chamber where the pressure inside the 2^{nd} liquid-storing chamber is lower than the pressure inside the 1^{st} liquid-storing chamber, said 2^{nd} liquid-storing chamber being disposed downstream of the 1^{st} liquid-storing chamber with respect to liquid flow.

In the above, in an embodiment, the connection path may be provided with a metering valve or check valve (e.g., 58) for reducing the pressure of the liquid passing therethrough.

In any of the aforesaid embodiments, the fluid mixing apparatus may further comprise a 3^{rd} liquid-storing chamber (e.g., 30) for storing liquid, said 3^{rd} liquid-storing chamber being pressurable, and a connection path (e.g., 55) connecting the 2^{nd} liquid-storing chamber and the 3^{rd} liquid-storing chamber for supplying liquid from the 2^{nd} liquid-storing chamber to the 3^{rd} liquid-storing chamber where the pressure inside the 3^{rd} liquid-storing chamber is lower than the pressure inside the 2^{nd} liquid-storing chamber, said 3^{rd} liquid-storing chamber being disposed downstream of the 2^{nd} liquid-storing chamber with respect to liquid flow.

In any of the aforesaid embodiments, the connection path connecting the 2^{nd} liquid-storing chamber and the 3^{rd} liquid-storing chamber may be provided with a metering valve or check valve (e.g., 59) for reducing the pressure of the liquid passing therethrough.

In any of the aforesaid embodiments, the 1^{st} liquid-storing chamber and the 2^{nd} liquid-storing chamber may be connected to the gas supply via a 1st valve (e.g., 15) and a 2^{nd} valve (e.g., 25) respectively, and the 1^{st} liquid-storing chamber may be connected to the liquid supply.

In any of the aforesaid embodiments, the 1^{st} liquid-storing chamber and the 2^{nd} liquid-storing chamber may be provided with 1^{st} and 2^{nd} pressure sensors (e.g., 13, 13) respectively.

In any of the aforesaid embodiments, the fluid mixing apparatus may further comprise a pressure controller (e.g., 60) for controlling the pressure inside the 1^{st} liquid-storing chamber and the pressure inside the 2^{nd} liquid-storing chamber respectively, by opening and closing the 1^{st} and 2^{nd} valves respectively, when the pressure inside the 1^{st} liquid-storing chamber and the pressure inside the 2^{nd} liquid-storing chamber detected respectively by the 1^{st} and 2^{nd} pressure sensors are lower than set pressures respectively set for the 1^{st} and 2^{nd} liquid-storing chambers.

In any of the aforesaid embodiments, the controller may be programmed to start increasing gas flow (e.g., by 10% to 60%, or 20% to 50%) for a given time period (e.g., until the pressure reaches a set value) supplied to the 1^{st} liquid-storing chamber by opening the 1^{st} valve, when the pressure inside the 1^{st} liquid-storing chamber detected by the 1^{st} pressure sensor is lower than the set pressure, and the controller is further programmed to start increasing gas flow for a given time period supplied to the 2^{nd} liquid-storing chamber by opening the 2^{nd} valve, when the pressure inside the 2^{nd} liquid-storing chamber detected by the 2^{nd} pressure sensor is lower than the set pressure.

In any of the aforesaid embodiments, the controller may be programmed to stop gas flow for a given time period (e.g., 2 to 7 minutes, for example 5 minutes) before starting increasing gas flow for the given time period measured after the gas flow exceeds the gas flow before being stopped in the 1^{st} and/or 2^{nd} liquid-storing chamber(s). A decrease of pressure inside the liquid-storing chamber may be indicative of non-optimum operation of the circulation pump for introducing liquid to the liquid-storing chamber, due to gas or bubbles contained in the liquid. By stopping gas flow, the concentration or quantity of gas contained in the liquid can be reduced so that the circulation pump can function normally, thereby stably controlling the system. Thus, in an embodiment, gas flow may be conducted intermittently, cyclically or in pulses.

In any of the aforesaid embodiments, the controller may be programmed to repeat stopping and increasing gas flow until the pressure inside the 1^{st} liquid-storing chamber reaches a given pressure set for the 1^{st} liquid-storing chamber, and/or repeat stopping and increasing gas flow until the pressure inside the 2^{nd} liquid-storing chamber reaches a given pressure set for the 2^{nd} liquid-storing chamber.

In any of the aforesaid embodiments, the 1^{st} and 2^{nd} liquid-storing chambers may be provided with 1^{st} and 2^{nd} supply pipes (e.g., 220a, 220c) disposed inside the 1^{st} and 2^{nd} liquid-storing chambers respectively, each of said 1^{st} and 2^{nd} supply pipes having multiple holes (e.g., 221) for discharging liquid outwardly from the inside of the supply pipe through the holes to the inside of the liquid-storing chamber above the liquid surface.

In any of the aforesaid embodiments, each of the 1^{st} and 2^{nd} liquid-storing chambers may be further provided with a liquid level setting device (e.g., 16) for setting a liquid level in the liquid-storing chamber, wherein the multiple holes are disposed substantially only in a portion of the supply pipe, which portion is located substantially above the set liquid level in the liquid-storing chamber.

In any of the aforesaid embodiments, the 1^{st} and 2^{nd} liquid-storing chambers may be further provided with 1^{st} and 2^{nd} sub-supply pipes (e.g., 220b, 220d) disposed inside the 1^{st} and 2^{nd} liquid-storing chambers respectively, each of said 1^{st} and 2^{nd} sub-supply pipes having multiple holes (e.g., 221) for discharging liquid outwardly from the inside of the supply pipe through the holes to the inside of the liquid-storing chamber above the liquid surface, wherein a lower end of the 1^{st} supply pipe is connected to the liquid supply, the 1^{st} sub-supply pipe constitutes a loop with a circulation path (e.g., 11, 12) for circulating the liquid inside the 1^{st} liquid-storing chamber, a lower end of the 2^{nd} supply pipe is connected to the 1^{st} liquid-storing chamber, and the 2^{nd} sub-supply pipe constitutes a loop with a circulation path (e.g., 21, 22) for circulating the liquid inside the 2^{nd} liquid-storing chamber.

In another embodiment of the present invention, a bath fluid mixing system may comprise: (i) a fluid mixing apparatus comprising: (a) a 1^{st} liquid-storing chamber (e.g., 10) for storing liquid and mixing gas into liquid, said 1^{st} liquid-storing chamber being pressurable; (b) a 2^{nd} liquid-storing chamber (e.g., 20) for storing liquid and mixing gas into liquid, said 2^{nd} liquid-storing chamber being pressurable; and (c) a connection path (e.g., 54) connecting the 1^{st} liquid-storing chamber and the 2^{nd} liquid-storing chamber for supplying liquid from the 1^{st} liquid-storing chamber to the 2^{nd} liquid-storing chamber where the pressure inside the 2^{nd} liquid-storing chamber is lower than the pressure inside the 1^{st} liquid-storing chamber, said 2^{nd} liquid-storing chamber being disposed downstream of the 1^{st} liquid-storing chamber with respect to liquid flow; (ii) a tub (e.g., 3) for storing liquid from the 2^{nd} liquid-storing chamber or from the 1^{st} and 2^{nd} liquid-storing chambers; (iii) a liquid supply (e.g., 51, 91) for supplying liquid to the 1^{st} liquid-storing chamber; (iv) a gas supply (e.g., 41) for supplying gas to the 1^{st} and 2^{nd} liquid-storing chamber; and (v) a liquid circulation loop (e.g., 52, 53, 54, 55, 56, 57, 71, 72) for circulating the liquid in the tub via the 1^{st} and 2^{nd} liquid-storing chambers.

In the above, the fluid mixing apparatus can be of any of the foregoing embodiments.

In the above, in an embodiment, the tub and the 2^{nd} liquid-storing chamber may be connected via a connection path (e.g., 72) provided with a metering valve or chock valve (e.g., 82) for breaking relatively large babbles generated or contained in liquid by passing the liquid through the valve. The relatively large bubbles can be broken down to more uniform and smaller bubbles in the liquid by passing through the valve due to high pressure upstream of the valve, low pressure immediately downstream of the valve, and high liquid flow immediately downstream of the valve. As the metering or chock valve, a venture pipe, orifice, throttle valve, butterfly valve, or any other suitable valves can be used.

In the above, the fluid mixing apparatus can be of any of the foregoing embodiments.

In the above, in an embodiment, the tub and the 1^{st} liquid-storing chamber may be connected via a connection path (e.g., 71) provided with a metering valve or chock valve (e.g., 81) for breaking babbles generated in liquid passing therethrough due to pressure difference between the 1^{st} liquid-storing chamber and the tub.

In still another embodiment of the present invention, a bath fluid mixing method may comprise: (I) supplying liquid and mixing gas into the liquid in a 1^{st} liquid-storing chamber (e.g., 10), said 1^{st} liquid-storing chamber being pressurable and provided with a 1^{st} pressure sensor (e.g., 13) and having a 1^{st} pressure, said gas being supplied to the 1^{st} storing chamber from a gas supply (e.g., 41) via a 1^{st} valve (e.g., 15); (II) supplying the liquid from the 1^{st} liquid-storing chamber to a 2^{nd} liquid-storing chamber (e.g., 20) and mixing gas into the liquid in the 2^{nd} liquid-storing chamber, said 2^{nd} liquid-storing chamber being pressurable and provided with a 2^{nd} pressure sensor (e.g., 23) and having a 2^{nd} pressure which is lower than the 1^{st} pressure, said gas being supplied to the 2^{nd} liquid-storing chamber from a gas supply (e.g., 41) via a 2^{nd} valve (e.g., 25); and (III) supplying the liquid from the 2^{nd} liquid-storing chamber or from the 1^{st} and 2^{nd} liquid-storing chambers to a tub.

Any suitable apparatus of the foregoing embodiments can be used in the method.

In the above, in an embodiment, the fluid mixing method may further comprise controlling the pressure inside the 1^{st} liquid-storing chamber and the pressure inside the 2^{nd} liquid-storing chamber respectively, by opening and closing the 1^{st} and 2^{nd} valves respectively, when the pressure inside the 1^{st} liquid-storing chamber and the pressure inside the 2^{nd} liquid-storing chamber detected respectively by the 1^{st} and 2^{nd} pressure sensors are lower than set pressures respectively set for the 1^{st} and 2^{nd} liquid-storing chambers.

In any of the aforesaid embodiments, the pressure controlling step may comprise starting increasing gas flow for a given time period supplied to the 1^{st} liquid-storing chamber by opening the 1^{st} valve, when the pressure inside the 1^{st} liquid-storing chamber detected by the 1^{st} pressure sensor is lower than the set pressure, and starting increasing gas flow for a given time period supplied to the 2^{nd} liquid-storing chamber by opening the 2^{nd} valve, when the pressure inside the 2^{nd} liquid-storing chamber detected by the 2^{nd} pressure sensor is lower than the set pressure.

In any of the aforesaid embodiments, the pressure controlling step may further comprise stopping gas flow for a given time period before starting increasing gas flow for the given time period measured after the gas flow exceeds the gas flow before being stopped in the 1^{st} and/or 2^{nd} liquid-storing chamber(s).

In any of the aforesaid embodiments, the pressure controlling may further repeat stopping and increasing gas flow until the pressure inside the 1^{st} liquid-storing chamber reaches a given pressure set for the 1^{st} liquid-storing chamber, and/or repeating stopping and increasing gas flow until the pressure inside the 2^{nd} liquid-storing chamber reaches a given pressure set for the 2^{nd} liquid-storing chamber.

In any of the aforesaid embodiments, the method may further comprise circulating the liquid between the 1^{st} and 2^{nd} liquid-storing chambers and the tub using a liquid circulation path (e.g., 52, 53, 54, 55, 56, 57, 71, 72) with a circulation pump (e.g., 57).

In any of the aforesaid embodiments, the set liquid level in the 1^{st} and/or 2^{nd} liquid-storing chamber may preferably be positioned between 30% to 70% (including 40%, 50%, 60%, and values between any two numbers of the foregoing) of a depth of the liquid-storing chamber. In an embodiment, the set liquid level in the liquid-storing chamber can be positioned between 20% to 80% of a depth of the liquid-storing chamber as long as the gas dissolution efficiency is good. If the position is too low, not enough liquid can be supplied in the liquid-storing chamber and not enough pressure can be applied to the shower. If the position is too high, the liquid discharged from the holes cannot have enough chances to be exposed to the gas in the liquid-storing chamber.

In any of the aforesaid embodiments, the supply pipe may preferably have a height which is greater than 50% (including 60%, 70%, 80%, 90%, and values between any two numbers of the foregoing) of a depth of the liquid-storing chamber for the reasons described above, especially when the supply pipe is erected upright from the bottom of the liquid-storing chamber. In an embodiment, an upper end of the supply pipe can touch or can be close to a ceiling of the liquid-storing chamber.

One or more supply pipes can be used in the liquid-storing chamber. When two supply pipes are used, one is for introducing liquid into the inside the liquid-storing chamber, and the other is for circulating the liquid in a loop inside the liquid-storing chamber. One or more additional supply pipes can be used for further circulating the liquid in a loop inside the liquid-storing chamber so as to increase mixing gas into the liquid.

In any of the aforesaid embodiments, the portion having the multiple holes of the supply pipe may preferably be disposed from an upper end to 20% to 65% (including 30%, 40%, 50%, 60%, and values between any two numbers of the foregoing) of the height of the supply pipe for the reasons described above. In an embodiment, the supply pipe can extend from the ceiling of the liquid-storing chamber, and in that case, the portion with the holes may be more than 60% of the length of the supply pipe which may be less than 50% of the depth of the liquid-storing chamber.

In any of the aforesaid embodiments, the liquid-storing chamber may preferably have a pressure release valve (e.g., 14, 24, 34) for releasing pressure inside the liquid-storing chamber when the pressure reaches a give level. If the pressure exceeds a given level, the release valve opens to adjust the inside pressure. This can be controlled by the external controller (e.g., 60) or the release valve can be automatically activated as a safety valve.

In an embodiment, the pressure inside the 1^{st} and 2^{nd} liquid-storing chambers may be about 1.5 atom to about 3.0 atom and about 1 atom to about 2.0 atom, respectively, and the difference in pressure between the 1^{st} and 2^{nd} liquid-storing chambers may be about 0.5 atom to about 2.0 atom (e.g., 1.0 to 1.5 atom) so that bubbles may be efficiently broken or dissipated as the liquid is moved from the 1^{st} liquid-storing chamber to the 2^{nd} liquid-storing chamber. If one or more additional liquid-storing chambers are used in series, the above pressure difference may be applied to the additional liquid-storing chamber(s) in series. The number of the liquid-storing chambers may be selected depending on the size of the tub, the size of each liquid-storing chamber, the desired concentration of gas in the liquid, etc. Normally, two or more chambers (three or four or more) can be used in series. The most downstream liquid-storing chamber may preferably be a chamber without a supply pipe. The most downstream liquid-storing chamber without a supply pipe may be smaller than those (with a supply pipe) disposed upstream of the most downstream liquid-storing chamber.

In any of the aforesaid embodiments, the size of the holes can be selected to create a shower which is composed of drops, mist, liquid stream, etc. In an embodiment, the size of the holes may be about 0.3 mm to about 2.0 mm (about 0.5 mm to about 0.8 mm in other embodiments), although the size can be bigger than 2.0 mm in an embodiment. The holes may preferably be boreholes, and more than 100 holes may be arranged substantially or nearly uniformly along the circumference of the portion of the supply pipe. By adjusting the revolution of the pump provided in the circulation path, it is possible to adjust the squirting size of the liquid from the holes. If the revolution is high, the supply pressure is high, and the squirting size of the liquid from the holes can be small so as to elevate the gas dissolution efficiency. The system configurations including the supply pressure may be selected so that the squirted liquid can reach an inner wall of the liquid-storing chamber.

In addition, if the tub is a personal tub, the liquid stored in the tub may be 45-60 litters (5-50 litters in other embodiments), and accordingly, the capacity of the liquid-storing chamber can be determined. If the mixing capacity of the liquid-storing chamber is high, the size of the liquid-storing chamber can be as small as less than ½ (⅓, ¼, ⅕, and values between any two numbers of the foregoing) of the liquid of the tub. In an embodiment, the capacity of the liquid-storing chamber may be in the range of 5-50 litters (including 10 litters, 20 litters, 30 litters, 40 litters, and values between any two numbers of the foregoing, preferably 10-30 litters). In an embodiment, the supply pipe may have a length of about 300 mm±50%.

In the present disclosure where conditions and/or structures are not specified, the skilled artisan in the art can readily provide such conditions and/or structures, in view of the present disclosure, as a matter of routine experimentation. Also, in the present disclosure, the numerical numbers applied in embodiments can be modified by a range of at least ±50% in other embodiments, and the ranges applied in embodiments may include or exclude the endpoints.

Examples of the present invention are explained below.

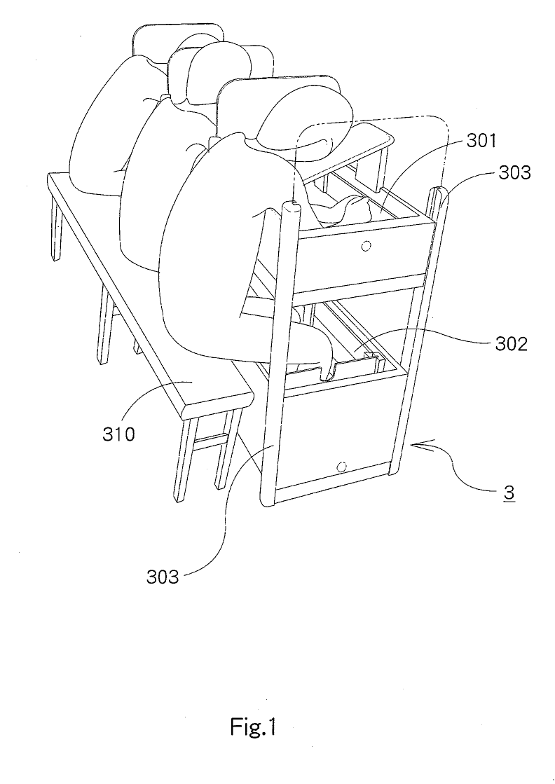

First, an example of a tub 3 that applies a tub apparatus conforming to the present invention is explained. FIG. 1 is a perspective view of a tub 3 that applies a tub apparatus conforming to this example of the present invention.

This tub 3 comprises an arm tub 301 and a leg tub 302, where both tubs are connected on top of each other via a pillar 303. The user sits on a long chair 310 installed in front of the tub 3, and soaks his or her arms in the arm tub 301 and legs in the leg tub 302, to locally promote blood circulation in the body.

Herein, an example of the present invention need not be applied to this tub 3 designed to soak only parts of the body, but it can be applied to a general tub designed to soak the entire body.

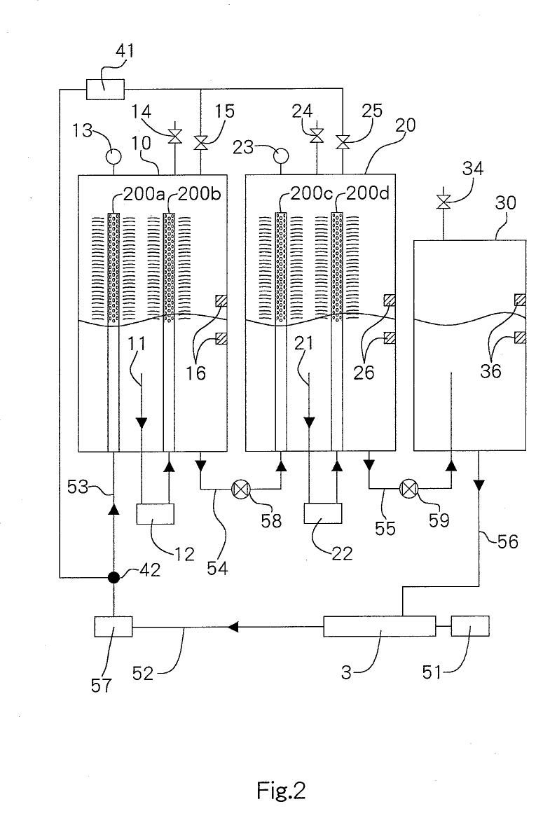

The configuration of a bath mixing apparatus conforming to an example of the present invention is explained. FIG. 2 is a schematic diagram of a bath mixing apparatus conforming to an example of the present invention.

This bath mixing apparatus is designed to supply to the tub 3 a mixed liquid comprising warm water mixed with carbon dioxide, and has a first mixing chamber 10, second mixing chamber 20 and liquid-storing chamber 30 at the bottom for storing the mixed liquid.

The first mixing chamber 10 has a pair of supply pipes 220 inside, where the pipes have many holes 221 explained later for injecting mixed liquid into the space above the level of mixed liquid stored in the first mixing chamber 10. One supply pipe 220 is connected to a conduit 53 for supplying the mixed liquid to the first mixing chamber 10. The other supply pipe 220 is connected to a conduit 11 that supplies mixed liquid by suctioning it from the middle layer of mixed liquid stored in the first mixing chamber 10 by the action of a circulation pump 12.

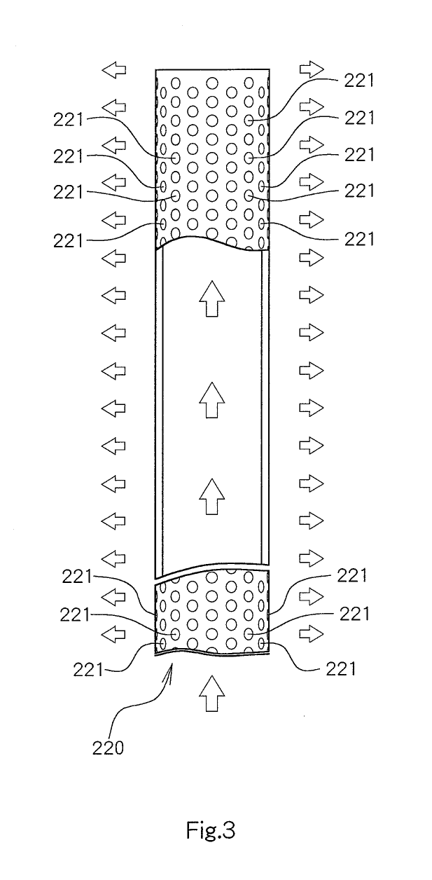

FIG. 3 is a partial side section view of the supply pipe 220.

Many holes 221 are provided in the section covering around a half of the top part of the supply pipe 220. By connecting this supply pipe 220 to the conduits 53, 11, mixed liquid is supplied to the first mixing chamber 10 through the many holes 221. Therefore, the mixed liquid is released in a shower form into the mixed liquid stored in the first mixing chamber 10 to enhance the dissolution efficiency of carbon dioxide. The same applies to the second mixing chamber 20 explained later.

Let's go back to FIG. 2 once again. In this first mixing chamber 10, a pair of level sensors 16 are provided for detecting the level of mixed liquid stored therein. This first mixing chamber 10 also has a pressure sensor 13 that measures the internal pressure of the first mixing chamber 10. Furthermore, this first mixing chamber 10 is connected to outside air via an open/close valve 14. In addition, this first mixing chamber 10 is connected to a gas supply part 41 that supplies carbon dioxide through an open/close valve 15.

The internal pressure of this first mixing chamber 10 is set to approx. 3 atmospheres. The pressure in this first mixing chamber 10 is constantly monitored by the pressure sensor 13, and opening/closing of the open/close valve 15 is controlled based on the pressure value detected by this pressure sensor 13. This open/close control is implemented by means of a control part 60 explained later.

The second mixing chamber 20 has a pair of supply pipes 220 inside, where the pipes have many holes 221 explained later for injecting mixed liquid into the space above the level of mixed liquid stored in the second mixing chamber 20. One supply pipe 220 is connected to a conduit 54, having a metering or chock valve 58 in the middle, for supplying the mixed liquid from the first mixing chamber 10 to the second mixing chamber 20. The other supply pipe 220 is connected to a conduit 21 that supplies mixed liquid by suctioning it from the middle layer of mixed liquid stored in the second mixing chamber 20 by the action of a circulation pump 22.

In this second mixing chamber 20, a pair of level sensors 26 are provided for detecting the level of mixed liquid stored therein. This second mixing chamber 20 also has a pressure sensor 23 that measures the internal pressure of the second mixing chamber 20. Furthermore, this second mixing chamber 20 is connected to outside air via an open/close valve 24. In addition, this second mixing chamber 20 is connected to the gas supply part 41 through an open/close valve 25.

The internal pressure of this second mixing chamber 20 is set to approx. 1.5 atmospheres, which is lower than the pressure of the first mixing chamber 10. The pressure in this second mixing chamber 20 is constantly monitored by the pressure sensor 23, and opening/closing of the open/close valve 25 is controlled based on the pressure value detected by this pressure sensor 23. This open/close control is implemented by means of a control part 60 explained later.

The liquid-storing chamber 30 is connected to a conduit 55, which has a metering or chock valve 59 in the middle, for supplying the mixed liquid from the second mixing chamber 20 to the liquid-storing chamber 30. This conduit 55 is configured in such a way that it discharges mixed liquid near the middle layer of mixed liquid stored in the liquid-storing chamber 30. Also, this liquid-storing chamber 30 is connected to the tub 3 via a conduit 56. In addition, this liquid-storing chamber 30 has a pair of level sensors 36 for detecting the level of mixed liquid stored therein. Furthermore, this liquid-storing chamber 30 is connected to outside air via an open/close valve 34.

The tub 3 is connected to a circulation pump 57 via a conduit 52. This circulation pump 57 connects to the supply pipe 220 in the first mixing chamber 10 via the conduit 53 described above. Also, a mixing mechanism 42 is provided in the conduit 53 for mixing the carbon dioxide supplied from the gas supply part 41 into the mixed liquid passing through the conduit 53. In addition, the tub 3 is connected to a liquid supply part 51 for supplying warm water to this tub 3.

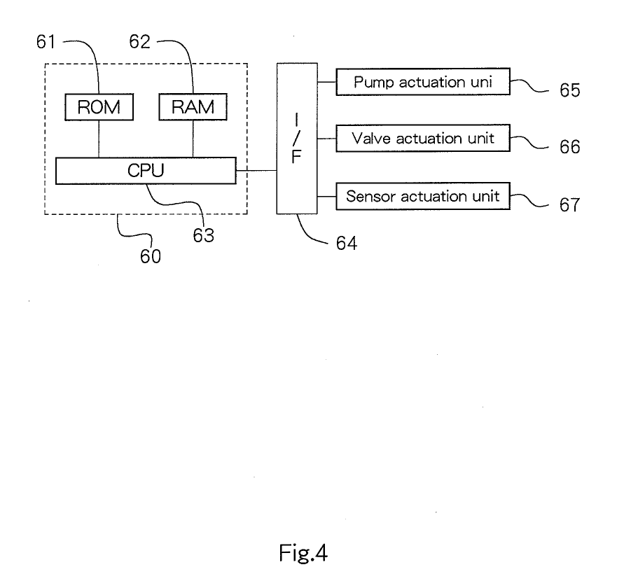

FIG. 4 is a block diagram of a key electrical configuration of a bath mixing apparatus conforming to an example of the present invention.

This bath mixing apparatus has a control part 60 comprising a ROM 61 that stores the operation program needed to control the apparatus, a RAM 62 that temporarily stores data, etc., during control, and a CPU 36 that executes logic calculations. This control part 60 connects, via an interface 64, to a pump drive part 65 for controlling the driving of each of the circulation pumps 12, 22, 57 described above. This control part 60 also connects, via the interface 64, to a valve drive part 66 for controlling the opening/closing of each of the valves 14, 15, 24, 25, 34 described above. Furthermore, this control part 60 connects, via the interface 64, to a sensor connection part 67 that connects the pressure sensors 13, 23 and level sensors 16, 26, 36 described above. This bath mixing apparatus executes various operations by means of control by this control part 60.

In the bath mixing apparatus having the configuration described above, the warm water supplied from the liquid supply part 51 to the tub is force-fed into the first mixing chamber 10 by the action of the circulation pump 57. At this time, carbon dioxide is mixed into the warm water by the action of the mixing mechanism 42 immediately before the warm water enters the first mixing chamber 10. The mixed liquid comprising warm water and carbon dioxide is injected into the space above the level of mixed liquid stored in the first mixing chamber 10, through the many holes 221 provided in the one supply pipe 220.

The space above the level of mixed liquid stored in the first mixing chamber 10 is filled with the carbon dioxide supplied from the gas supply part 41. When mixed liquid is injected from the many holes 221 in the supply pipe 220 and contacts this carbon dioxide, the carbon dioxide concentration in the mixed liquid increases. Also, the mixed liquid stored in the first mixing chamber 10 is injected again, by the action of the circulation pump 12 and through the many holes 221 in the other supply pipe 220, into the space above the level of mixed liquid stored in the first mixing chamber 10. This further increases the carbon dioxide concentration in the mixed liquid.

The conduit 54 between the first mixing chamber 10 and second mixing chamber 20 has the metering or chock valve 58. The pressure in the first mixing chamber 10 is maintained at 3 atmospheres by the action of the carbon dioxide supplied from the gas supply part 41 via the open/close valve 15 and also by the action of this metering or chock valve 58. Accordingly, more carbon dioxide is taken into the mixed liquid in the first mixing chamber 10.

The mixed liquid force-fed into the second mixing chamber 20 via the metering or chock valve 58 is injected into the space above the level of mixed liquid stored in the second mixing chamber 20, through the many holes 221 in the one supply pipe 220.

The space above the level of mixed liquid stored in the second mixing chamber 20 is also filled with the carbon dioxide supplied from the gas supply part 41. When mixed liquid is injected from the many holes 221 in the supply pipe 220 and contacts this carbon dioxide, the carbon dioxide concentration in the mixed liquid increases. Also, the mixed liquid stored in the second mixing chamber 20 is injected again, by the action of the circulation pump 22 and through the many holes 221 in the other supply pipe 220, into the space above the level of mixed liquid stored in the second mixing chamber 20. This further increases the carbon dioxide concentration in the mixed liquid.

The conduit 55 between the second mixing chamber 20 and liquid-storing chamber 30 has the metering or chock valve 59. The pressure in the second mixing chamber 20 is maintained at 1.5 atmospheres by the action of the carbon dioxide supplied from the gas supply part 41 via the open/close valve 25 and also by the action of this metering or chock valve 59. By keeping the pressure in the second mixing chamber 20 at a level lower than the pressure in the first mixing chamber 10, carbon dioxide is partially released from the mixed liquid as bubbles. As a result, generation of bubbles from the mixed liquid supplied to the liquid-storing chamber 30 can be reduced.

The mixed liquid force-fed into the liquid-storing chamber 30 via the metering or chock valve 59 is temporarily stored in the liquid-storing chamber 30. The pressure in this liquid-storing chamber 30 corresponds to the atmospheric pressure, and carbon dioxide is partially released from the mixed liquid as bubbles also in this liquid-storing chamber 30. As a result, generation of bubbles from the mixed liquid supplied to the tub 3 can be reduced. The carbon dioxide collected in the top section of the liquid-storing chamber 30 is released to atmosphere, if necessary, via the open/close valve 34. For your information, this carbon dioxide can be collected into the gas supply part 41. It is also possible to mix this carbon dioxide into the mixed liquid passing through the conduit 52 or conduit 53.

In the aforementioned example, the pressure in the first mixing chamber 10 is set to 3 atmospheres, while the pressure in the second mixing chamber 20 is set to 1.5 atmospheres. However, the second mixing chamber 20 may be set to any other pressure as long as it is equal to or higher than the atmospheric pressure and lower than the pressure in the first mixing chamber 10. In other words, the pressure in the second mixing chamber 20 may be the same as the atmospheric pressure.

Also in the aforementioned example, warm water is supplied to the tub 3 from the liquid supply part 51. However, it is sufficient that this warm water is supplied to one of the mixed liquid circulation lines including the circulation lines for the first mixing chamber 10, second mixing chamber 20, liquid-storing chamber 30 and tub 3.

Similarly in the aforementioned example, the carbon dioxide supplied from the gas supply part 41 is supplied into mixed liquid via the mixing mechanism 42 provided in the conduit 53. However, it is sufficient that this carbon dioxide is supplied to one of the mixed liquid circulation lines including the circulation lines for the first mixing chamber 10, second mixing chamber 20, liquid-storing chamber 30 and tub 3.

Also in the aforementioned example, carbon dioxide is dissolved in mixed liquid by utilizing the supply pipes 220 with many holes 221 as described later, which are used to inject mixed liquid into the space above the levels of mixed liquid stored in the first mixing chamber 10 and second mixing chamber 20. However, it is possible to increase the content of dissolved carbon dioxide in the mixed liquid by injecting more mixed liquid into the mixed liquid stored in the first mixing chamber 10 and second mixing chamber 20, or by generating convection flows in the mixed liquid stored in the first mixing chamber 10 and second mixing chamber 20.

Also in the aforementioned example, the liquid-storing chamber 30 is used in addition to the first and second mixing chambers 10, 20. However, this liquid-storing chamber 30 may be omitted and mixed liquid may be supplied directly to the tub 3 from the second mixing chamber.

Next, another example of a bath mixing apparatus conforming to the present invention is explained.

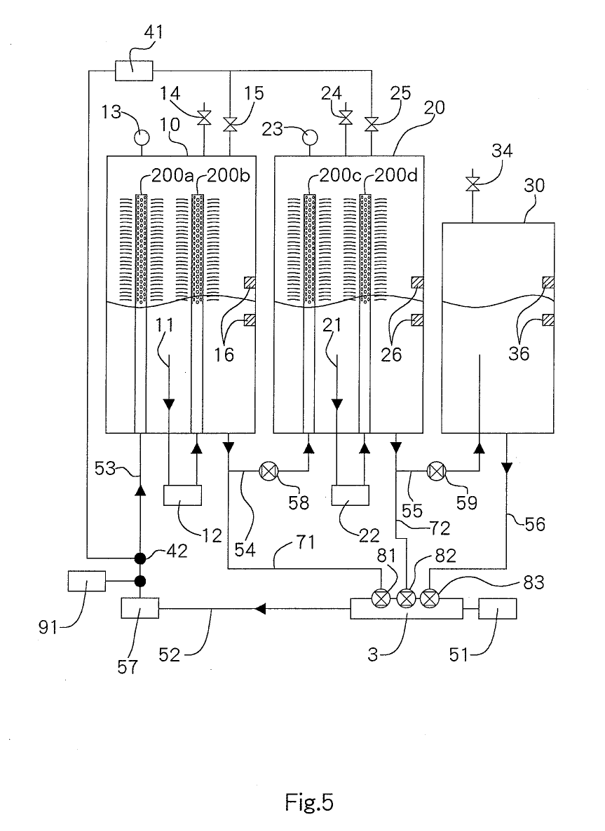

FIG. 5 is a schematic diagram of another example of a bath mixing apparatus conforming to the present invention. As shown in FIG. 5, the bath mixing apparatus conforming to this example further has: a conduit 71 that branches from the conduit 54 and supplies mixed liquid from the first mixing chamber 10 to the tub 3; a conduit 72 that branches from the conduit 55 and supplies mixed liquid from the second mixing chamber 20 to the tub 3; metering or chock valves 81, 82, 83 positioned near the water feed ports to the tub 3 along the conduits 71, 72, 56; and a liquid supply part 91 in the conduit 53 that connects the circulation pump 57 to the first mixing chamber 10. In FIG. 5, the same components used in the example described earlier are denoted by the same symbols and their detailed explanation is omitted.

In this example having the conduit 71 capable of supplying mixed liquid from the first mixing chamber 10 to the tub 3, and the conduit 72 capable of supplying mixed liquid from the second mixing chamber 20 to the tub 3, a desired supply channel of mixed liquid can be selected according to the condition of use, etc. To be specific, when recirculating from the tub 3 to a mixing chamber the mixed liquid whose content of dissolved carbon dioxide has saturated, the liquid need not pass through multiple mixing chambers, but carbon dioxide dissociated in the tub 3 can be added to the mixed liquid in a single chamber instead, or it is also possible to supply mixed liquid from the first mixing chamber 10 or second mixing chamber 20 to the tub 3 directly in order to increase the circulation speed of mixed liquid. In this case, there is no need to supply an excess amount of carbon dioxide to each mixing chamber from the liquid supply part 41, and therefore the air pressure in the first mixing chamber 10 may be set to approx. 1.5 atmospheres, while the air pressure in the second mixing chamber 20 may be set to the same as the atmospheric pressure, and still generation of bubbles occurring as a result of pressure difference between the mixed liquids supplied from the two chambers to the tub 3 can be reduced.

Providing the metering or chock valves 81, 82, 83 near the supply ports of mixed liquid to the tub 3 along the conduits 71, 72, 56 allows the bubbles generating as a result of pressure difference between the mixed liquids supplied from the respective mixing chambers to the tub 3 to be made finer by means of pressurization at the metering or chock valves 81, 82, 83. This reduces the unpleasant feel of the user in the tub 3 caused by the contact of large bubbles with the user's skin, and also allows bubbles to break easily because their size is smaller.

If the flow rate of mixed liquid circulated from the tub 3 to the first mixing chamber 10 is low, the liquid supply part 91 can supply additional liquid to the flow channel 53 as deemed appropriate. To be specific, when liquid is supplied directly from the liquid supply part 51 to the tub 3 while the user is using the tub 3, the carbon dioxide concentration in the tub 3 drops and the thermal bath effect also decreases. Therefore, the liquid supply part 91 is connected to the flow channel 53 that runs after the tub 3 but before the first mixing tub. This configuration allows additional liquid to be added while the user is using the tub 3, without reducing the carbon dioxide concentration in the tub 3.

The liquid supply part 91 can also be configured in such a way that water is supplied to the conduit 53 from a water system via a supply valve, etc. In this example, it is also possible to supply water, warm water, etc., from the liquid supply part 91 only.

The operation of adjusting the feed rate of gas based on the detected pressure value in each mixing chamber is explained further by referring to FIGS. 2, 4 and 5 again.

As shown in FIG. 4, the sensor connection part 67 and valve drive part 66 are connected via the interface 64 to the control part 60. The sensor connection part 67 is connected to the pressure sensors 13, 23, while the valve drive part 66 is connected to the valves 15, 25 that adjust the feed rate of gas supplied from the gas supply part 41.

In the bath mixing apparatus having the aforementioned control system, the feed rate of gas is increased by opening/closing the valve 15 or valve 25 when the pressure value detected by the pressure sensor 13 or pressure sensor 23 drops to below a specified value pre-stored in the ROM 61, such as 3 atmospheres for the first mixing chamber 10 and 1.5 atmospheres for the second mixing chamber 20. At this time, gas supply is stopped for a certain period, after which gas is supplied to the first mixing chamber 10, second mixing chamber 20, etc., by increasing, for a certain preset period, the feed rate of gas from the level before the gas supply was stopped. It is also possible to repeat the operation of stopping the gas supply for a certain period until the pressure stabilizes at a specified value, and the operation of supplying gas for a certain period at a feed rate higher than before the gas supply was stopped. By adding a configuration to implement such control, the pressure in each mixing chamber can be maintained at a certain level or higher. As a result, mixed liquid in which gas is dissolved at high concentration can be supplied stably.

The aforementioned adjustment of gas feed rate based on pressure values detected by pressure sensors is particularly effective in a bath mixing apparatus shown in FIG. 2 or 5, where the mixed liquid already mixed with gas and stored in the tub 3 is recirculated by the driving force of the circulation pump 57 located in the conduit between the tub 3 and first mixing chamber 10. To be specific, the mixed liquid is fed from the tub 3 to the circulation pump 57 and enters the circulation pump 57, upon which the liquid is agitated in the pump by the pump action and a large amount of bubbles generates. These bubbles create cavities in the flow of mixed liquid comprising gas and liquid, and causes cavitation. This cavitation may reduce the pump performance or even shorten the service life of the pump. If the bath mixing apparatus is operated continuously in this condition, its pressures, particularly the pressure in the first mixing chamber 10, will decrease gradually and mixed liquid with low dissolved gas content will be supplied to the tub 3 as a result. This phenomenon can be prevented by adjusting the gas feed rate based on the pressure values detected by pressure sensors.

Also in the adjustment of gas feed rate, it is also possible to make adjustment based on, for example, the detected values of carbonic acid gas concentration sensors, etc. However, carbonic acid gas concentration sensors are expensive and will add to the fabrication cost of the bath mixing apparatus. To make the apparatus configuration simple and easy, a bath mixing apparatus conforming to an example of the present invention adopts a configuration whereby the gas feed rate is adjusted based on the pressure values detected by pressure sensors.

It is also possible to provide flow rate sensors, etc., along, for example, the supply conduits 56, 71, 72 of mixed liquid to the tub 3, as shown in FIG. 2 or 5, to implement the adjustment whereby the speed of the circulation pump 57 is raised or the gas feed rate from the liquid supply parts 51, 91 is increased when the flow rate drops to below a specified level, in addition to adjusting the gas flow rate based on the pressure values detected by pressure sensors.

The present invention includes the above mentioned embodiments and other various embodiments including the following:

### Embodiment 1

A bath mixing apparatus for supplying to a tub a mixed liquid comprising liquid mixed with gas, said bath mixing apparatus characterized by having: (i) a first mixing chamber having supply pipes through which mixed liquid is supplied, used to store mixed liquid at the bottom, and having a first internal pressure maintained at a level higher than the atmospheric pressure; (ii) a second mixing chamber having supply pipes through which mixed liquid is supplied, used to store mixed liquid at the bottom, and having a second internal pressure maintained at a level equal to or higher than the atmospheric pressure but lower than the first pressure in the first chamber; (iii) a mixed liquid circulation mechanism for circulating mixed liquid through the chambers in the order of the first mixing chamber and second mixing chamber and then returning it to the tub; (iv) a liquid supply part that supplies liquid to one of the mixed liquid circulation lines including the circulation lines for the tub, first mixing chamber and second mixing chamber; and (v) a gas supply part that supplies gas to one of the mixed liquid circulation lines including the circulation lines for the tub, first mixing chamber and second mixing chamber.

### Embodiment 2

A bath mixing apparatus according to Embodiment 1, further having: (I) a gas supply line that connects the first and second mixing chambers to the gas supply part via a valve; (II) sensors that measure the pressures in the first and second mixing chambers; and (III) a control part that controls the opening/closing of the valve based on the pressure values detected by the sensors.

### Embodiment 3

A bath mixing apparatus according to Embodiment 1 or 2, wherein a metering or chock valve is provided between the first mixing chamber and second mixing chamber, and also between the second mixing chamber and tub.

### Embodiment 4

A bath mixing apparatus according to Embodiment 1 or 2, wherein a liquid-storing chamber is provided between the second mixing chamber and tub for temporarily storing mixed liquid.

### Embodiment 5

A bath mixing apparatus according to any one of Embodiments 1 to 4, wherein the supply pipes have many holes for injecting mixed liquid into the space above the levels of mixed liquid stored in the first and second mixing chambers.

### Embodiment 6

A bath mixing apparatus according to Embodiment 5, wherein sensors are provided that detect the levels of mixed liquid stored in the first and second mixing chambers.

### Embodiment 7

A bath mixing apparatus according to any one of Embodiments 1 to 6, wherein a metering or chock valve is provided near the supply port to the tub along the conduit through which to supply mixed liquid to the tub.

### Embodiment 8

A bath mixing apparatus according to any one of Embodiments 2 to 7, wherein the feed rate of gas supplied from the gas supply part is increased for a certain period if the pressure values detected by the sensors drop to below a specified value.

### Embodiment 9

A bath mixing apparatus according to Embodiment 8, wherein the supply of gas from the gas supply part is stopped for a certain period if the pressure values detected by the sensors drop to below a specified value, and after elapse of a specified period the feed rate of gas supplied from the gas supply part is increased for a certain period to a level higher than the feed rate before the supply was stopped.

### Embodiment 10

A bath mixing apparatus according to Embodiment 9, wherein the control part repeats the stopping and supplying of gas for a certain period until a specified pressure is reached.

The present application claims priority to Japanese Patent Application No. 2006-304660, filed Nov. 10, 2006, No. 2007-124115, filed May 9, 2007, and No. 2007-218069, filed Aug. 24, 2007, the disclosure of which is incorporated herein by reference in their entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A fluid mixing apparatus configured to be connected to a tub, a liquid supply, and a gas supply, comprising:
a 1^{st} liquid-storing chamber for storing liquid and mixing gas into liquid, said 1^{st} liquid-storing chamber being pressurable;
a 2^{nd} liquid-storing chamber for storing liquid and mixing gas into liquid, said 2^{nd} liquid-storing chamber being pressurable; and
a connection path connecting the 1^{st} liquid-storing chamber and the 2^{nd} liquid-storing chamber for supplying liquid from the 1^{st} liquid-storing chamber to the 2^{nd} liquid-storing chamber where the pressure inside the 2^{nd} liquid-storing chamber is lower than the pressure inside the 1^{st} liquid-storing chamber, said 2^{nd} liquid-storing chamber being disposed downstream of the 1^{st} liquid-storing chamber with respect to liquid flow.

2. The fluid mixing apparatus according to claim 1, wherein the connection path is provided with a metering valve or check valve for reducing the pressure of the liquid passing therethrough.

3. The fluid mixing apparatus according to claim 1, further comprising a 3^{rd} liquid-storing chamber for storing liquid, said 3^{rd} liquid-storing chamber being pressurable, and a connection path connecting the 2^{nd} liquid-storing chamber and the 3^{rd} liquid-storing chamber for supplying liquid from the 2^{nd} liquid-storing chamber to the 3^{rd} liquid-storing chamber where the pressure inside the 3^{rd} liquid-storing chamber is lower than the pressure inside the 2^{nd} liquid-storing chamber, said 3^{rd} liquid-storing chamber being disposed downstream of the 2^{nd} liquid-storing chamber with respect to liquid flow.

4. The fluid mixing apparatus according to claim 3, wherein the connection path connecting the 2^{nd} liquid-storing chamber and the 3^{rd} liquid-storing chamber is provided with a metering valve or check valve for reducing the pressure of the liquid passing therethrough.

5. The fluid mixing apparatus according to claim 1, wherein the 1^{st} liquid-storing chamber and the 2^{nd} liquid-storing chamber are connected to the gas supply via 1i^{st} and 2^{nd} valves respectively, and the 1^{st} liquid-storing chamber is connected to the liquid supply.

6. The fluid mixing apparatus according to claim 5, wherein the 1^{st} liquid-storing chamber and the 2^{nd} liquid-storing chamber are provided with 1^{st} and 2^{nd} pressure sensors respectively.

7. The fluid mixing apparatus according to claim 6, further comprising a pressure controller for controlling the pressure inside the 1^{st} liquid-storing chamber and the pressure inside the 2^{nd} liquid-storing chamber respectively, by opening and closing the 1^{st} and 2^{nd} valves respectively, when the pressure inside the 1^{st} liquid-storing chamber and the pressure inside the 2^{nd} liquid-storing chamber detected respectively by the 1^{st} and 2^{nd} pressure sensors are lower than set pressures respectively set for the 1^{st} and 2^{nd} liquid-storing chambers.

8. The fluid mixing apparatus according to claim 7, wherein the controller is programmed to start increasing gas flow for a given time period supplied to the 1^{st} liquid-storing chamber by opening the 1^{st} valve, when the pressure inside the 1^{st} liquid-storing chamber detected by the 1^{st} pressure sensor is lower than the set pressure, and the controller is further programmed to start increasing gas flow for a given time period supplied to the 2^{nd} liquid-storing chamber by opening the 2^{nd} valve, when the pressure inside the 2^{nd} liquid-storing chamber detected by the 2^{nd} pressure sensor is lower than the set pressure.

9. The fluid mixing apparatus according to claim 8, wherein the controller is programmed to stop gas flow for a given time period before starting increasing gas flow for the given time period measured after the gas flow exceeds the gas flow before being stopped in the 1^{st} and/or 2^{nd} liquid-storing chamber(s).

10. The fluid mixing apparatus according to claim 9, wherein the controller is programmed to repeat stopping and increasing gas flow until the pressure inside the 1^{st} liquid-storing chamber reaches a given pressure set for the 1^{st} liquid-storing chamber, and/or repeat stopping and increasing gas flow until the pressure inside the 2^{nd} liquid-storing chamber reaches a given pressure set for the 2^{nd} liquid-storing chamber.

11. The fluid mixing apparatus according to claim 1, wherein the 1^{st} and 2^{nd} liquid-storing chambers are provided with 1^{st} and 2^{nd} supply pipes disposed inside the 1^{st} and 2^{nd} liquid-storing chambers respectively, each of said 1^{st} and 2^{nd} supply pipes having multiple holes for discharging liquid outwardly from the inside of the supply pipe through the holes to the inside of the liquid-storing chamber above the liquid surface.

12. The fluid mixing apparatus according to claim 11, wherein each of the 1^{st} and 2^{nd} liquid-storing chambers is further provided with a liquid level setting device for setting a liquid level in the liquid-storing chamber, wherein the multiple holes are disposed substantially only in a portion of the supply pipe, which portion is located substantially above the set liquid level in the liquid-storing chamber.

13. The fluid mixing apparatus according to claim 11, wherein the 1^{st} and 2^{nd} liquid-storing chambers are further provided with 1^{st} and 2^{nd} sub-supply pipes disposed inside the 1^{st} and 2^{nd} liquid-storing chambers respectively, each of said 1^{st} and 2^{nd} sub-supply pipes having multiple holes for discharging liquid outwardly from the inside of the supply pipe through the holes to the inside of the liquid-storing chamber above the liquid surface, wherein a lower end of the 1^{st} supply pipe is connected to the liquid supply, the 1^{st} sub-supply pipe constitutes a loop with a circulation path for circulating the liquid inside the 1^{st} liquid-storing chamber, a lower end of the 2^{nd} supply pipe is connected to the 1^{st} liquid-storing chamber, and the 2^{nd} sub-supply pipe constitutes a loop with a circulation path for circulating the liquid inside the 2^{nd} liquid-storing chamber.

14. A bath fluid mixing system comprising:
(i) a fluid mixing apparatus comprising:
a 1^{st} liquid-storing chamber for storing liquid and mixing gas into liquid, said 1^{st} liquid-storing chamber being pressurable;
a 2^{nd} liquid-storing chamber for storing liquid and mixing gas into liquid, said 2^{nd} liquid-storing chamber being pressurable; and
a connection path connecting the 1^{st} liquid-storing chamber and the 2^{nd} liquid-storing chamber for supplying liquid from the 1^{st} liquid-storing chamber to the 2^{nd} liquid-storing chamber where the pressure inside the 2^{nd} liquid-storing chamber is lower than the pressure inside the 1^{st} liquid-storing chamber, said 2^{nd} liquid-storing chamber being disposed downstream of the 1^{st} liquid-storing chamber with respect to liquid flow;
(ii) a tub for storing liquid from the 2^{nd} liquid-storing chamber or from the 1^{st} and 2^{nd} liquid-storing chambers;
(iii) a liquid supply for supplying liquid to the 1^{st} liquid-storing chamber;
(iv) a gas supply for supplying gas to the 1^{st} and 2^{nd} liquid-storing chamber; and
(v) a liquid circulation loop for circulating the liquid in the tub via the 1^{st} and 2^{nd} liquid-storing chambers.

15. The fluid mixing system according to claim 14, wherein the tub and the 2^{nd} liquid-storing chamber are connected via a connection path provided with a metering valve or chock valve for breaking babbles generated in liquid passing therethrough due to pressure difference between the 1^{st} liquid-storing chamber and the tub.

16. The fluid mixing system according to claim 15, wherein the tub and the 1^{st} liquid-storing chamber are connected via a connection path provided with a metering valve or chock valve for breaking babbles generated in liquid passing therethrough due to pressure difference between the 1^{st} liquid-storing chamber and the tub.

17. A bath fluid mixing method comprising:
supplying liquid and mixing gas into the liquid in a 1^{st} liquid-storing chamber, said 1^{st} liquid-storing chamber being pressurable and provided with a 1^{st} pressure sensor and having a 1^{st} pressure, said gas being supplied to the 1^{st} storing chamber from a gas supply via a 1^{st} valve;
supplying the liquid from the 1^{st} liquid-storing chamber to a 2^{nd} liquid-storing chamber and mixing gas into the liquid in the 2^{nd} liquid-storing chamber, said 2^{nd} liquid-storing chamber being pressurable and provided with a 2^{nd} pressure sensor and having a 2^{nd} pressure which is lower than the 1^{st} pressure, said gas being supplied to the 2^{nd} liquid-storing chamber from a gas supply via a 2^{nd} valve; and
supplying the liquid from the 2^{nd} liquid-storing chamber or from the 1^{st} and 2^{nd} liquid-storing chambers to a tub.

18. The fluid mixing method according to claim 17, further comprising controlling the pressure inside the 1^{st} liquid-storing chamber and the pressure inside the 2^{nd} liquid-storing chamber respectively, by opening and closing the 1^{st} and 2^{nd} valves respectively, when the pressure inside the 1^{st} liquid-storing chamber and the pressure inside the 2^{nd} liquid-storing chamber detected respectively by the 1^{st} and 2^{nd} pressure sensors are lower than set pressures respectively set for the 1^{st} and 2^{nd} liquid-storing chambers.

19. The fluid mixing method according to claim 18, wherein the pressure controlling step comprises starting increasing gas flow for a given time period supplied to the 1^{st} liquid-storing chamber by opening the 1^{st} valve, when the pressure inside the 1^{st} liquid-storing chamber detected by the 1^{st} pressure sensor is lower than the set pressure, and starting increasing gas flow for a given time period supplied to the 2^{nd} liquid-storing chamber by opening the 2^{nd} valve, when the pressure inside the 2^{nd} liquid-storing chamber detected by the 2^{nd} pressure sensor is lower than the set pressure.

20. The fluid mixing method according to claim 19, wherein the pressure controlling step further comprises stopping gas flow for a given time period before starting increasing gas flow for the given time period measured after the gas flow exceeds the gas flow before being stopped in the 1^{st} and/or 2^{nd} liquid-storing chamber(s).

21. The fluid mixing method according to claim 20, wherein the pressure controlling further repeating stopping and increasing gas flow until the pressure inside the 1^{st} liquid-storing chamber reaches a given pressure set for the 1^{st} liquid-storing chamber, and/or repeating stopping and increasing gas flow until the pressure inside the 2^{nd} liquid-storing chamber reaches a given pressure set for the 2^{nd} liquid-storing chamber.

22. The fluid mixing method according to claim 17, further comprising circulating the liquid between the 1^{st} and 2^{nd} liquid-storing chambers and the tub.
